(19) United States
(12) Patent Application Publication
(10) Pub. No.: US 2013/0183177 A1
(43) Pub. Date: Jul. 18, 2013

(54) Tubing Encased Motor Lead

(71) Applicant: Schlumberger Technology Corporation, Sugar Land, TX (US)

(72) Inventors: Greg H. Manke, Overland Park, KS (US); Patrick Zhiyuan Ma, Ct. Lawrence, KS (US); Jason Holzmueller, Lawrence, KS (US)

(73) Assignee: SCHLUMBERGER TECHNOLOGY CORPORATION, Sugar Land, TX (US)

(21) Appl. No.: 13/742,349

(22) Filed: Jan. 16, 2013

Related U.S. Application Data
(60) Provisional application No. 61/586,849, filed on Jan. 16, 2012.

(51) Int. Cl. H01B 7/02; F04B 17/03; H01R 43/00

(52) U.S. Cl. CPC H01B 7/0291; H01R 43/00; F04B 17/03
USPC 417/422; 174/105 R; 174/105 SC; 29/825

(57) ABSTRACT

A system and methodology facilitates the supply of electrical power in a variety of harsh environments. The technique may utilize an electrical power cable having an insulator located around an electrical conductor. The insulator and the electrical conductor are positioned within a metallic tube. In a variety of applications, the metallic tube enables construction of the electrical power cable without an armor layer. A jacket is disposed between the insulator and the metallic tube and is designed to compensate for differences in thermal expansion between the materials. The jacket may be formed with gas pockets distributed therein to compensate for a different level of thermal expansion of the jacket relative to, for example, the metallic tube.

### CROSS-REFERENCE TO RELATED APPLICATION

The present document is based on and claims priority to U.S. Provisional Application Ser. No. 61/586,849, filed Jan. 16, 2012, incorporated herein by reference.

### BACKGROUND

In many hydrocarbon well applications, power cables are employed to deliver electrical power to various devices. For example, electrical power cables may be used to provide power to electric submersible pumping systems. In well applications, the electrical power cable comprises a motor lead extension having an electrical conductor, insulation, and metallic armor. The motor lead extension often incorporates a barrier layer formed of lead to prevent well fluid and gas from migrating into the cable and attacking the insulation. However, lead is susceptible to damage and is difficult to use in forming metal-to-metal seals of the type used in a variety of downhole applications. The external armor can be used to provide some protection for the lead barrier.

### SUMMARY

In general, a system and methodology is provided for supplying electric power in a variety of harsh environments. The technique may utilize an electrical power cable having an insulator located around an electrical conductor. The insulator and the electrical conductor are positioned within a metallic tube. In a variety of applications, the metallic tube is formed without lead to provide a mechanically strong, corrosion resistant, gas and well fluid impermeable layer. Depending on the application, the metallic tube may allow construction of the electrical power cable without an armor layer. A jacket is disposed between the insulator and the metallic tube and is designed to compensate for differences in thermal expansion between the materials. The jacket may be formed with gas pockets distributed therein to compensate for a different level of thermal expansion of the jacket relative to, for example, the metallic tube.

However, many modifications are possible without materially departing from the teachings of this disclosure. Accordingly, such modifications are intended to be included within the scope of this disclosure as defined in the claims.

### BRIEF DESCRIPTION OF THE DRAWINGS

Certain embodiments of the disclosure will hereafter be described with reference to the accompanying drawings, wherein like reference numerals denote like elements. It should be understood, however, that the accompanying figures illustrate the various implementations described herein and are not meant to limit the scope of various technologies described herein, and:

FIG. 1 is a schematic illustration of a well system comprising an example of an electric submersible pumping system deployed in a wellbore and connected with an electrical power cable, according to an embodiment of the disclosure;

FIG. 2 is an orthogonal view of an embodiment of an electrical power cable, according to an embodiment of the disclosure;

FIG. 3 is an orthogonal view of another embodiment of an electrical power cable, according to an embodiment of the disclosure;

FIG. 4 is an orthogonal view of another embodiment of an electrical power cable, according to an embodiment of the disclosure; and

FIG. 5 is an illustration of metallic tubing of an embodiment of the electric power cable being plastically deformed into engagement with an interior material, according to an embodiment of the disclosure;

### DETAILED DESCRIPTION

In the following description, numerous details are set forth to provide an understanding of some embodiments of the present disclosure. However, it will be understood by those of ordinary skill in the art that the system and/or methodology may be practiced without these details and that numerous variations or modifications from the described embodiments may be possible.

The present disclosure generally relates to a system and methodology for delivering electric power. The technique employs an electrical power cable designed to enable operation in a variety of harsh environments, such as high heat, downhole environments associated with many types of well applications. By way of example, the electrical power cable has an electrical conductor surrounded by an insulator formed of at least one layer of insulation. The insulator and the electrical conductor are positioned within a metallic tube and a jacket is positioned radially between the metallic tube and the combined insulator and electrical conductor.

The metallic tube may be formed of a mechanically strong material which allows the electrical power cable to be designed without an armor layer in many applications. Additionally, the metallic tube may be formed without using the relatively soft lead associated with various existing barrier layer designs. The jacket is disposed between the insulator and the metallic tube and is designed to compensate for differences in thermal expansion between the materials. The jacket may be formed with gas pockets distributed therein to create a foam material able to compensate for greater thermal expansion of the jacket relative to, for example, the metallic tube. In addition to or in lieu of the gas pockets created throughout the elastomeric material, the gas pockets may be formed between the elastomeric material and an inside surface of the metallic tube by creating exterior surface features along the elastomeric material.

Because many difficult environments, e.g. well environments, have high temperatures, high pressures, and/or deleterious gases and other fluids, the power cable is designed with layers, e.g. the metallic tubing, which prevent gas and other fluids from migrating into the cable and attacking the interior of the cable. The strong, metallic tubing of the power cable also facilitates metal-to-metal seals with connectors or other components. Additionally, the jacket layer is readily compressible which facilitates long-term, dependable use of the electrical power cable in high heat environments even though adjacent materials have different coefficients of thermal expansion.

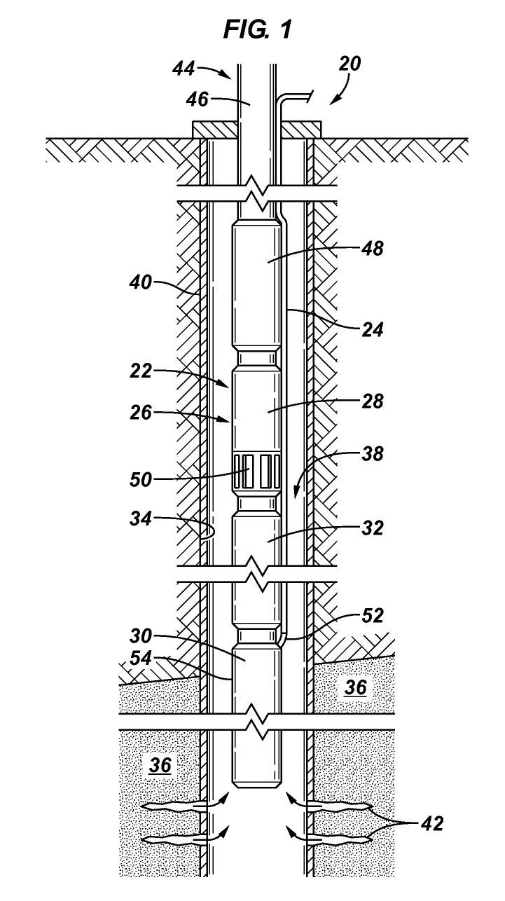

Referring generally to FIG. 1, an embodiment of a well system is illustrated as comprising a downhole, electrically powered system, e.g an electric submersible pumping system. By way of example, the system may comprise a variety of electric submersible pumping system components deployed in a well string located in a wellbore. Electric power is delivered downhole into the harsh, subterranean environment via an electrical power cable which may be connected to the electric submersible pumping system via a motor lead extension. The illustrated electric submersible pumping system or other types of well systems may comprise many types of components and may be employed in many types of applications and environments, including cased wells and open-hole wells. The well system also may be utilized in vertical wells or deviated wells, e.g. horizontal wells.

Referring again to FIG. 1, a well system 20 is illustrated as comprising an electrically powered system 22 which receives electrical power via an electrical power cable 24. By way of example, the electrically powered system 22 may be in the form of an electric submersible pumping system 26, and the power cable 24 is designed to withstand high temperature, harsh environments. Although the electric submersible pumping system 26 may have a wide variety of components, examples of such components comprise a submersible pump 28, a submersible motor 30, and a motor protector 32.

In the example illustrated, electric submersible pumping system 26 is designed for deployment in a well 34 located within a geological formation 36 containing, for example, petroleum or other desirable production fluids. A wellbore 38 may be drilled and lined with a wellbore casing 40, although the electric submersible pumping system 26 (or other type of electrically powered system 22) may be used in open hole wellbores or in other environments exposed to high temperatures and harsh conditions. In the example illustrated, however, casing 40 may be perforated with a plurality of perforations 42 through which production fluids flow from formation 36 into wellbore 38. The electric submersible pumping system 26 may be deployed into a wellbore 38 via a conveyance or other deployment system 44 which may comprise tubing 46, e.g. coiled tubing or production tubing. By way of example, the conveyance 44 may be coupled with the electrically powered system 22 via an appropriate tubing connector 48.

In the example illustrated, electrical power is provided to submersible motor 30 by electrical power cable 24. The submersible motor 30, in turn, powers submersible pump 28 which draws in fluid, e.g. production fluid, into the pumping system through a pump intake 50. The fluid is produced or moved to the surface or other suitable location via tubing 46. However, the fluid may be pumped to other locations along other flow paths. In some applications, for example, the fluid may be pumped along an annulus surrounding conveyance 44. In other applications, the electric submersible pumping system 26 may be used to inject fluid into the subterranean formation or to move fluids to other subterranean locations.

As described in greater detail below, the electrical power cable 24 is designed to consistently deliver electric power to the submersible pumping system 26 over long operational periods in environments subject to high temperatures, high pressures, deleterious fluids, and/or other harsh conditions. The power cable 24 is connected to the corresponding, electrically powered component, e.g. submersible motor 30, by a suitable power cable connector 52, e.g. a suitable pothead. The cable connector 52 provides sealed and protected passage of the power cable conductor or conductors through a housing 54 of submersible motor 30. The cable connector 52 may utilize a metal-to-metal seal utilizing a high-strength outer tube (see metallic tube 60 described below) used to form the power cable 24, e.g. motor lead extension.

Depending on the application, the power cable 24 may comprise an individual electrical conductor protected by an insulation system or a plurality of electrical conductors protected by the insulation system. In various submersible pumping applications, the electrical power cable 24 is in the form of a motor lead extension. In many of these applications, the motor lead extension 24 is designed to carry three-phase current, and submersible motor 30 comprises a three-phase motor powered by the three-phase current delivered through the three electrical conductors of motor lead extension 24.

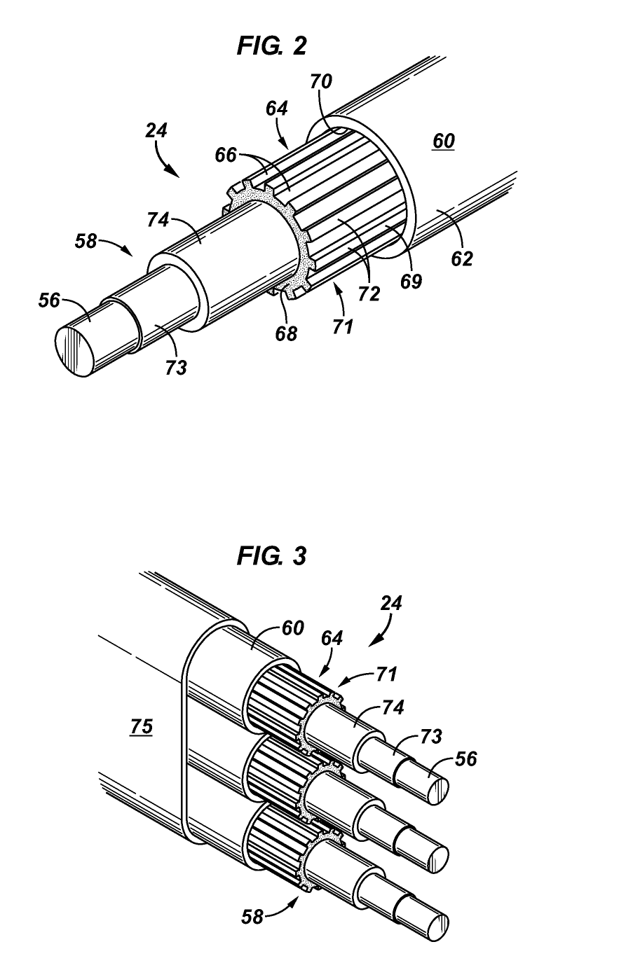

Referring generally to FIG. 2, an example of electrical power cable 24, e.g. motor lead extension, is illustrated. In this example, the power cable 24 comprises an electrical conductor 56 and an insulator 58 disposed around the electrical conductor 56. A metallic tube 60 is disposed around the insulator 58. In many applications, the metallic tube 60 provides a robust, metallic layer which is mechanically strong and corrosion resistant. For example, the metallic tube 60 may be formed without lead and may comprise a variety of steel alloys or other materials which provide strength and corrosion resistance. The non-lead, strong, metallic tube 60 increases the longevity and reliability of electrical power cable 24 and also offers a smooth and robust exterior surface 62 for metal-to-metal seal construction. Due to the robustness of the metallic tubing 60, the power cable 24 may be designed without external, metallic armor because the metallic tube 60, e.g. steel alloy tube, sufficiently protects the power cable 24 from mechanical damage.

A jacket 64 is disposed radially between the insulator 58 and the metallic tube 60. By way of example, the jacket 64 may be formed from a compressible material, such as an elastomeric material, which is able to compensate for different coefficients of thermal expansion between adjacent materials, such as different coefficients of thermal expansion between the material forming jacket 64 and the material forming metallic tube 60. In many applications, jacket 64 may be formed from elastomeric material which has a higher coefficient of thermal expansion and thus a greater thermal expansion than the surrounding metallic tube 60 for a given increase in temperature.

By way of example, the jacket 64 may be formed as a compressible material by distributing gas pockets 66 throughout the material to compensate for the greater thermal expansion of the jacket relative to that of the metallic tube 60 when the temperature of the electrical power cable 24 is increased. In one embodiment, the jacket 64 is formed with a sponge material 68, such as an elastomeric sponge material. The porosity of the sponge material 68 offers spaces which compensate for the increasing volume of the sponge material 68 as temperatures increase. However, the elastomeric character of the sponge material 68 also serves to enable squeezing of the jacket 64 between the insulator 58 and the metallic tube 60 and to ensure a tight fit between an exterior 69 of jacket 64 and an interior surface 70 of metallic tube 60.

In some applications, the jacket 64 may be formed with external surface features 71 designed so that the jacket 64 is in partial contact with the metallic tube 60. For example, the external surface features 71 may comprise spirals or splines 72 or other types of surface features 71 which form gas pockets 66 between jacket 64 and interior surface 70 of metallic tube 60. In some applications, the jacket 64 may be formed from sponge material 68 having internal gas pockets 66 while also comprising external surface features 71 which create additional gas pockets 66 along the interior surface 70 of metallic tube 60. The clearance created in the spaces between the external surface features 71 provides additional space for thermal expansion of jacket 64 relative to metallic tube 60 at higher temperatures.

Depending on the application, the jacket 64 may be formed of sponge material 68 bonded to the insulator 58 or left unbonded. A number of different elastomers may be used to form the sponge material 68, including EPDM, HNBR, NBR, SBR, Silicones, Fluorosilicones, chlorinated polyethylene, chloroprene, butyl, FEPM, or other extrudable elastomers that can be processed into a sponge compound. The sponge characteristic of the elastomer can be created by a gas-creating additive added into the rubber compound itself, by gas injection into an extruder crosshead during processing, and/or by other suitable techniques for creating sponge material.

In an embodiment of the electrical power cable 24, the sponge material 68 may be nonconductive and designed to provide additional dielectric strength to the cable. This type of sponge material 68 also contributes to the improved reliability of the cable design. In another example, the sponge material 68 may be semi-conductive and able to act as an insulation shield. This type of sponge material 68 can be useful when used in power cables 24 operated at medium to high voltage as it will lower the electrical stress between the insulation and the metallic barrier.

By way of example, the jacket 64 may be extruded over insulator 58. If the jacket 64 is formed of elastomeric sponge material 68, the elastomeric sponge material may be extruded over the insulator. However, the jacket 64 may be placed around insulator 58 by various other techniques, such as molding, layering, wrapping, or other suitable techniques. Similarly, the jacket 64, along with electrical conductor 56 and insulator 58, may be positioned within metallic tube 60 by a variety of techniques. For example, metallic tube 60 may be extruded over jacket 64 or the metallic tube 60 may be plastically deformed into engagement with the jacket 64 once the electrical conductor 56, insulator 58, and jacket 64 are positioned within an interior of the metallic tube 60. One example of the plastic deformation technique comprises swaging, as discussed in greater detail below. However, other techniques may be employed to insert the conductor 56, insulator 58, and jacket 64 into the metallic tube 60 and to create a secure contact between interior surface 70 of metallic tube 60 and the exterior 69 of jacket 64.

The electrical power cable 24 may comprise a variety of other and/or additional components depending on the environment in which the power cable 24 is to be employed and on the parameters of a given application. For example, insulator 58 may comprise a variety of insulating materials and constructions. In some embodiments, the insulator 58 may comprise an individual layer, and other embodiments may utilize a plurality of insulation layers, e.g. insulation layers 73 and 74. Each layer of the plurality of layers may be formed of a different material and/or a different type of construction. For example, insulation layer 73 may comprise a tape wrapped insulation layer which is wrapped over the electrical conductor 56. Insulation layer 74 may comprise an extruded insulation layer which is extruded over the tape wrapped insulation layer 73. These and other configurations of insulator 58 may be used to provide the desired insulation between electrical conductor 56 and jacket 64.

The electrical power cable 24 also may be constructed in a variety of configurations having, for example, an individual electrical conductor 56 or a plurality of electrical conductors 56. For example, a plurality of electrical conductors 56 may be arranged to form a generally flat power cable, as illustrated in FIG. 3. In this example, jacket 64 is disposed individually around each electrical conductor 56 and its associated insulator 58. Similarly, the metallic tube 60 is positioned individually around each jacket 64. The individual metallic tubes 60 may be held together by an external layer 75, such as a sheath, wrap, armor, or other suitable layer designed to bind the plurality of conductors 56 together into the power cable 24. However, the jacket 64 and the metallic tube 60 can be formed to collectively enclose the plurality of electrical conductors 56 and associated insulators 58. With the generally flat power cable construction, the collective outer metallic tube 60 can be formed with a flattened or elongated cross-section having an interior sized to receive the collective jacket 64 with internal conductors 56.

In the example illustrated in FIG. 3, the electrical power cable 24 is illustrated as having three electrical conductors 56. Depending on the application, other numbers of electrical conductors may be employed to deliver power to, for example, the downhole electrically powered system 22. In many applications, the use of three electrical conductors 56 allows delivery of three-phase power to the electrically powered system 22. For example, the power cable 24 may be designed as a three-phase power cable for delivering three-phase power to submersible motor 30 of electric submersible pumping system 26. In such applications, the electric submersible pumping system motor 30 is designed as a three-phase motor.

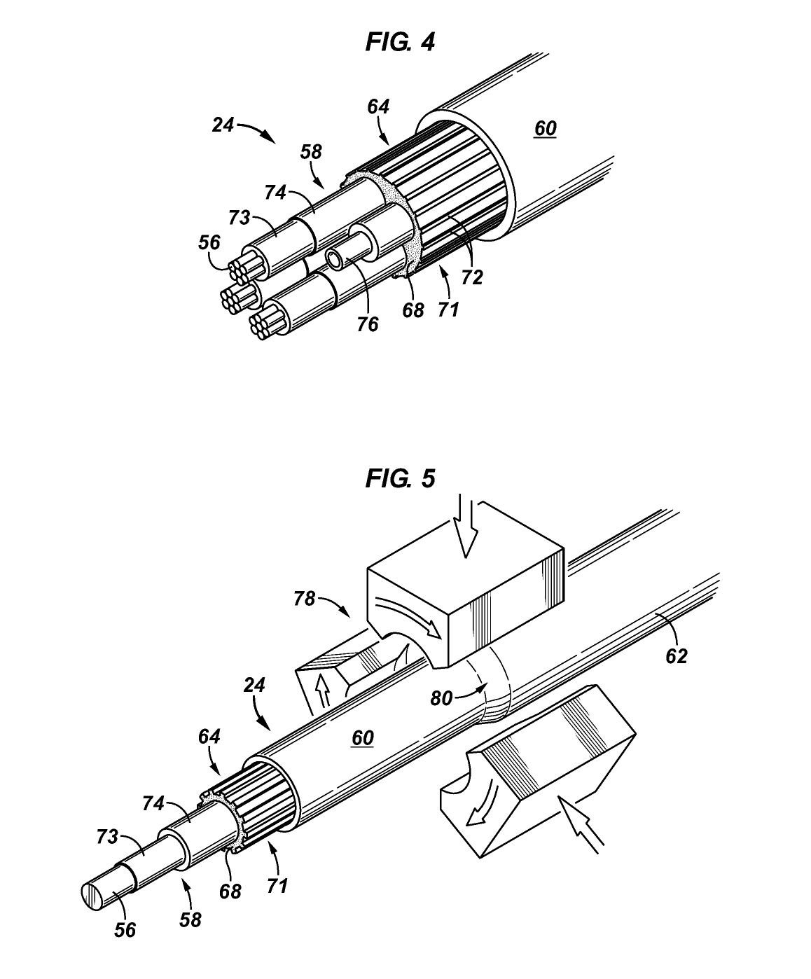

Referring generally to FIG. 4, an example is provided of a power cable 24 having a plurality of electrical conductors collectively surrounded by jacket 64. In this example, a plurality of electrical conductors, e.g. three electrical conductors for carrying three-phase power, is deployed within the power cable 24. Each electrical conductor 56 may be individually surrounded by insulator 58 having, for example, a plurality of insulation layers 73, 74. The collective group of electrical conductors 56 and associated insulators 58 is surrounded by jacket 64, as illustrated. The collective jacket 64, in turn, is positioned within metallic tube 60. In some applications, an additional control line or control lines 76, e.g. hydraulic control lines and/or fiber optic control lines, may be positioned within the power cable 24.

Referring generally to FIG. 5, a method of power cable construction is illustrated in which the outer metallic tube 60 is plastically deformed to achieve contact between the interior surface 70 of the metallic tube 60 and the jacket 64. In many applications, the metallic tube 60 may be plastically deformed until the jacket 64 is radially compressed to a desired extent. In this example, electrical conductor 56 (or a plurality of electrical conductors 56), corresponding insulator 58, and jacket 64 are initially inserted into the interior of metallic tube 60. The metallic tube 60 is then swaged by a metal swaging tool 78. The metallic tube 60 is swaged down to a predetermined diameter as evidenced by the diameter transition region 80 illustrated in FIG. 5.

The swaging plastically deforms the metallic tube 60 until the exterior or outer surface 69 of the jacket 64 contacts the inner surface 70 of the metallic tubing 60. In some applications, the metallic tube 60 is swaged until the jacket 64 is radially compressed to a desired extent. The contact between the metallic tube 60 and the jacket 64 enables the creation of friction resisting relative movement between the metallic tube 60 and jacket 64. The friction can be used to create a force sufficient to support the weight of the electrical conductor 56 (or conductors) and to prevent the electrical conductor 56 from sliding or dropping out of the metallic tube 60 due to gravity. This frictional support reduces or removes tension that could otherwise be applied at various connection locations.

The electrical power cable 24 may have a variety of sizes and/or constructions. For example, the power cable 24 may be designed with an individual conductor or other numbers of conductors depending on the parameters of a given application. Various types of insulators may be formed of individual or plural layers having many types of constructions to provide the desired insulation for the corresponding electrical conductor. The jacket also may be formed of a variety of materials and with many types of gas pockets located along the jacket. For example, many types of internal gas pockets may be formed to create a sponge material having a desired porosity and compressibility to accommodate differences in thermal expansion between adjacent materials. The jacket also may comprise many types of external features to create gas pockets between the jacket and the surrounding metallic tube. Similarly, the metallic tube may be formed from a variety of materials and in a variety of sizes. For example, the metallic tube may be formed from steel alloys, other metallic alloys, metals combined with other materials to form composite tubing, and other suitable metallic materials which provide the stronger and more robust material relative to lead.

Additionally, the power cable 24 may be used in a variety of downhole applications and other non-well related applications. For example, the power cable 24 may be used to deliver three-phase power to downhole electric submersible pumping systems. However, other types of power cables may be employed to deliver power to subterranean environments and to power a variety of electrically powered systems 22. The power cable also may be employed in other types of subterranean environments as well as surface environments, such as high temperature and high pressure surface environments or other types of harsh surface environments.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

What is claimed is:

1. An electrical power cable, comprising:
an electrical conductor;
an insulator disposed around the electrical conductor;
a metallic tube disposed around the insulator, the metallic tube being formed without lead; and
a jacket disposed between the insulator and the metallic tube, the jacket being formed of an elastomeric sponge material having a coefficient of thermal expansion higher than that of the material forming the metallic tube.

2. The electrical power cable as recited in claim 1, wherein the jacket comprises an external surface feature positioned to reduce contact between the elastomeric sponge material and an inside surface of the metallic tube.

3. The electrical power cable as recited in claim 2, wherein the external surface feature comprises a plurality of splines.

4. The electrical power cable as recited in claim 1, wherein the jacket is extruded over the insulator.

5. The electrical power cable as recited in claim 1, wherein the elastomeric sponge material is electrically nonconductive.

6. The electrical power cable as recited in claim 1, wherein the elastomeric sponge material is electrically semi-conductive.

7. The electrical power cable as recited in claim 1, wherein the insulator comprises a plurality of insulation layers.

8. The electrical power cable as recited in claim 7, wherein the plurality of insulation layers comprises a tape wrapped insulation layer and an extruded insulation layer.

9. The electrical power cable as recited in claim 1, wherein the electrical conductor comprises a plurality of electrical conductors in which each electrical conductor is individually surrounded by the jacket.

10. The electrical power cable as recited in claim 1, wherein the electrical conductor comprises a plurality of electrical conductors in which the electrical conductors are collectively surrounded by the jacket.

11. The electrical power cable as recited in claim 1, wherein the electrical conductor, the insulator, the metallic tube, and the jacket are combined to form a motor lead extension having a connector end shaped for connection to an electric submersible pumping system.

12. A method of forming an electrical power cable able to compensate for thermal expansion, comprising:
locating an insulator around an electrical conductor;
positioning the insulator and the electrical conductor within a metallic tube; and
radially separating the metallic tube from the insulator with a jacket having gas pockets distributed therein to compensate for differences in thermal expansion of the jacket relative to the metallic tube when the temperature of the electrical power cable increases.

13. The method as recited in claim 12, further comprising forming the jacket with an elastomeric foam material having the gas pockets distributed through the elastomeric foam material.

14. The method as recited in claim 13, wherein forming further comprises forming the gas pockets along an interior surface of the metallic tube via external surface features of the jacket.

15. The method as recited in claim 12, wherein the jacket is extruded onto the insulator and then inserted into an interior of the metallic tube.

16. The method as recited in claim 12, further comprising plastically deforming the metallic tube in a radially inward direction until an interior surface of the metallic tube contacts an exterior of the jacket.

17. The method as recited in claim 12, wherein locating the insulator comprises locating a plurality of insulation layers around the electrical conductor.

18. The method as recited in claim 12, further comprising: forming the metallic tube without lead; and electrically coupling the electrical conductor to an electric submersible pumping system.

19. A system for pumping wellbore fluids, comprising:
an electric submersible pumping system having a submersible pump powered by a submersible motor; and
an electrical power cable coupled to the submersible motor, the electrical power cable comprising:
an electrical conductor;
an insulator disposed around the electrical conductor;
a metallic tube disposed around the insulator; and
a jacket disposed between the insulator and the metallic tube, the jacket having gas pockets distributed therein to compensate for differences in thermal expansion between different materials of the electrical power cable.

20. The system as recited in claim 19, wherein the electrical conductor comprises a plurality of electrical conductors.
